(19) United States
(12) Patent Application Publication
(10) Pub. No.: US 2021/0252639 A1
(43) Pub. Date: Aug. 19, 2021

(54) METHODS OF ADDITIVE MANUFACTURING FOR GLASS STRUCTURES

(71) Applicant: Corning Incorporated, Corning, NY (US)

(72) Inventors: Michael Thomas Gallagher, Painted Post, NY (US); Scott Michael Jarvis, Ithaca, NY (US); Xinghua Li, Horseheads, NY (US); Nicholas Ryan Wheeler, Corning, NY (US)

(21) Appl. No.: 17/252,546

(22) PCT Filed: Jun. 7, 2019
(86) PCT No.: PCT/US2019/035976

§ 371 Date: Dec. 15, 2020

Related U.S. Application Data
(60) Provisional application No. 62/686,316, filed on Jun. 18, 2018.

(51) Int. Cl. B23K 26/34; B23K 26/06; B23K 26/067; B29C 64/295; C03B 19/02

(52) U.S. Cl. CPC B23K 26/34; B23K 26/0648; B23K 2103/54; B29C 64/295; C03B 19/02; B23K 26/067

(57) ABSTRACT

A method for forming a structure includes providing a glass or glass ceramic tubular structure (110) having an interior (150) and exterior surface (160) and at least a partially closed end region (140); heating the glass or glass ceramic tubular structure (110) to at least its softening point by: providing a laser beam; directing the laser beam (130) down the interior surface of the glass or glass ceramic tubular structure (110), at least some of the laser beam (130) directed at an angle greater than a predetermined incidence angle; and the laser beam (130) impinging on the closed end region (140) where at least some of the laser beam (130) is absorbed by the closed end region (140) of the glass or glass ceramic tubular structure; and moving at least one of: the glass or glass ceramic tubular structure or the end region relative to each other to form at least a two-dimensional shape from the glass or glass ceramic tubular structure.

### CROSS REFERENCE TO RELATED APPLICATIONS

This application claims the benefit of priority of U.S. Provisional Application Ser. No. 62/686,316, filed on Jun. 18, 2018, the contents of which are relied upon and incorporated herein by reference in their entirety.

### FIELD

The disclosure relates to additive manufacturing processes for inorganic materials.

### TECHNICAL BACKGROUND

Additive manufacturing (AM) (also known as three dimensional (3D) printing or rapid prototyping) refers to processes where layers of material are formed under computer control to create three-dimensional objects by extrusion deposition, light polymerization, powder bed sintering, lamination, and metal wire deposition, for example. Conventional AM processes have often employed polymers, metals, and ceramics.

Additive manufacturing of glass and glass ceramic materials have typically involved laser-based, binder-less approaches (e.g., glass-tubing, powder bed fusion, and blown-glass powder); however, traditional AM processes suffer from unnecessarily complex equipment configurations. For example, in AM using glass tubing, multiple laser beams (at least three) are needed to externally heat the glass tubing uniformly. The melted glass may be deposited or manipulated to form a glass article. The multiple beams can be generated by splitting a single laser beam, using multiple lasers, or using multiple reflections generated from optics. Thus, conventional AM processes for glass and glass-ceramic materials introduce system complexity and potential laser beam interference with the formed glass article.

The present application discloses improved additive manufacturing processes for inorganic materials. Specifically, the disclosure relates to additive manufacturing processes that allow for precise shaping of glasses and glass ceramics in three dimensions.

### SUMMARY

In some embodiments, a method for forming a structure comprises: providing a glass or glass ceramic tubular structure having an interior and exterior surface and at least a partially closed end region; heating the glass or glass ceramic tubular structure to at least its softening point by: (i) providing a laser beam; (ii) directing the laser beam down the interior surface of the glass or glass ceramic tubular structure; (iii) wherein at least some of the laser beam is directed at an angle greater than a predetermined incidence angle; and (iv) the laser beam impinges on the closed end region such that at least some of the laser beam is absorbed by the closed end region of the glass or glass ceramic tubular structure; and moving at least one of: the glass or glass ceramic tubular structure or the end region relative to each other such that at least a two-dimensional shape is formed from the glass or glass ceramic tubular structure.

In one aspect, which is combinable with any of the other aspects or embodiments, the step of providing the laser beam comprises directing the laser beam into the glass or glass ceramic tubular structure via an optical lens.

In one aspect, which is combinable with any of the other aspects or embodiments, the step of providing the laser beam comprises positioning the laser inside the glass or glass ceramic tubular structure via a glass or polymer fiber.

In one aspect, which is combinable with any of the other aspects or embodiments, the glass or polymer fiber is hollow and has an interior surface, wherein the beam is transmitted through the glass or polymer fiber via reflection off the interior surface at an angle greater than the predetermined incidence angle.

In one aspect, which is combinable with any of the other aspects or embodiments, the glass or polymer fiber is not hollow and the beam is transmitted through the glass or polymer fiber via total internal reflection.

In one aspect, which is combinable with any of the other aspects or embodiments, the glass or polymer fiber has a radially symmetric index profile.

In one aspect, which is combinable with any of the other aspects or embodiments, the predetermined incidence angle is 85° or more.

In one aspect, which is combinable with any of the other aspects or embodiments, the laser beam has a wavelength in a range of 2 μm to 12 μm.

In one aspect, which is combinable with any of the other aspects or embodiments, the laser beam has a linearly polarized LP mode comprising LP₀₁, LP₀₂, LP₀₃, LP₃₁ or LP₂₁.

In one aspect, which is combinable with any of the other aspects or embodiments, the glass or glass ceramic tubular structure has an absorbance of at least 0.05 at a wavelength of the laser beam.

In one aspect, which is combinable with any of the other aspects or embodiments, the glass or glass ceramic tubular structure has an outer diameter and an inner diameter, the outer diameter being from 500 μm to 10 mm and the inner diameter being from 50 μm to 9 mm.

In one aspect, which is combinable with any of the other aspects or embodiments, the at least two-dimensional shape is a three-dimensional shape.

In some embodiments, a method of forming an article comprises: providing a glass or glass ceramic cylindrical structure having an exterior surface, an exterior diameter, and an end region; providing a glass or glass ceramic tubular structure having an interior surface, an exterior surface, an interior diameter, an exterior diameter, and a focusing region, wherein the interior diameter of the glass or glass ceramic tubular structure is greater than the exterior diameter of the glass or glass ceramic cylindrical structure; positioning the glass or glass ceramic cylindrical structure inside the glass or glass ceramic tubular structure such that the end region of cylindrical structure is positioned in the focusing region of the tubular structure; heating the glass or glass ceramic cylindrical structure to at least its softening point by: (i) providing a laser beam; (ii) directing the laser beam through the glass or glass ceramic tubular structure via total internal reflection; (iii) wherein at least some of the laser beam exits the focusing region; and (iv) the laser beam impinges on the end region such that at least some of the laser beam is absorbed by the end region; and moving at least one of the glass or glass ceramic tubular structure or the end region relative to each other such that at least a two-dimensional shape is formed from the glass or glass ceramic cylindrical structure.

In one aspect, which is combinable with any of the other aspects or embodiments, the glass or glass ceramic cylindrical structure comprises a hollow tube having an interior surface and wherein the end region is at least partially closed.

In one aspect, which is combinable with any of the other aspects or embodiments, the laser beam has a wavelength in a range of 2 μm to 12 μm.

In one aspect, which is combinable with any of the other aspects or embodiments, the step of providing the laser beam comprises positioning the laser inside the glass or glass ceramic tubular structure via a glass or polymer fiber.

In one aspect, which is combinable with any of the other aspects or embodiments, the glass or polymer fiber has a radially symmetric index profile.

In one aspect, which is combinable with any of the other aspects or embodiments, the laser beam has a linearly polarized LP mode comprising LP₀₁, LP₀₂, LP₀₃, LP₃₁ or LP₂₁.

In one aspect, which is combinable with any of the other aspects or embodiments, the glass or glass ceramic cylindrical structure has an absorbance of at least 0.05 at a wavelength of the laser beam.

In one aspect, which is combinable with any of the other aspects or embodiments, the exterior diameter of the glass or glass ceramic tubular structure is in a range of 500 μm to 10 mm and the interior diameter of the glass or glass ceramic tubular structure is in a range of 50 μm to 9 mm; and the exterior diameter of the glass or glass ceramic cylindrical structure is in a range of 1 mm to 20 mm.

In one aspect, which is combinable with any of the other aspects or embodiments, the exterior diameter of the glass or glass ceramic tubular structure is in a range of 2 mm to 7 mm and the interior diameter of the glass or glass ceramic tubular structure is in a range of from at least a wavelength of the laser beam to 6.95 mm; and the exterior diameter of the glass or glass ceramic cylindrical structure is in a range of 2 mm to 7 mm.

In one aspect, which is combinable with any of the other aspects or embodiments, the at least two-dimensional shape is three-dimensional shape.

In one aspect, which is combinable with any of the other aspects or embodiments, the method further comprises tapering a portion of the interior surface of the glass or glass ceramic tubular structure such that the interior diameter of the glass or glass ceramic tubular structure increases to approach the exterior diameter of the glass or glass ceramic tubular structure.

In one aspect, which is combinable with any of the other aspects or embodiments, the method further comprises tapering a portion of the exterior surface of the glass or glass ceramic tubular structure such that the exterior diameter of the glass or glass ceramic tubular structure decreases to approach the interior diameter of the glass or glass ceramic tubular structure.

In some embodiments, a method for forming a structure comprises: providing a glass or glass ceramic cylindrical structure having a closed end region; heating the glass or glass ceramic cylindrical structure to at least its softening point by: (i) providing a laser beam; and (ii) impinging the laser beam on the closed end region such that at least some of the laser beam is absorbed by the closed end region; and moving the end region such that at least a two-dimensional shape is formed from the glass or glass ceramic cylindrical structure.

In one aspect, which is combinable with any of the other aspects or embodiments, the step of providing the laser beam comprises directing the laser beam via a lens, a mirror, and a reflector.

In one aspect, which is combinable with any of the other aspects or embodiments, the lens is an axicon lens, the mirror is a parabolic mirror, and the reflector is a conical reflector.

In one aspect, which is combinable with any of the other aspects or embodiments, directing the laser beams comprises: transforming the laser beam into a diverging ring-shaped laser beam via the lens; and transforming the diverging ring-shaped laser beam into a constant diameter ring-shaped beam via the mirror.

These and other aspects, advantages, and salient features will become apparent from the following detailed description, the accompanying drawings, and the appended claims.

### BRIEF DESCRIPTION OF THE DRAWINGS

Referring to the drawings in general, it will be understood that the illustrations are for describing particular embodiments and are not intended to limit the disclosure or appended claims thereto. The drawings are not necessarily to scale, and certain features and certain views of the drawings may be shown exaggerated in scale or in schematic in the interest of clarity and conciseness.

The disclosure will become more fully understood from the following detailed description, taken in conjunction with the accompanying figures, in which:

FIG. 1 illustrates an internal laser heating schematic according to some embodiments whereby light is coupled into a glass tube using a focusing lens.

FIG. 2 illustrates an internal laser heating schematic according to some embodiments whereby light is coupled into a glass tube using optical fiber.

FIG. 3 illustrates an experimental scheme of an internal laser heating schematic utilizing optical fiber.

FIG. 4 illustrates an internal laser heating schematic according to some embodiments whereby light is coupled into a glass tube using optical fiber.

FIG. 5 illustrates an internal laser heating schematic according to some embodiments whereby light is transmitted by optical fiber.

FIG. 6 illustrates an internal laser heating schematic according to some embodiments whereby light is transmitted by optical fiber.

FIG. 7 illustrates a glass tubing heating mechanism having a combination of axicon, parabolic mirror and conical reflector.

FIG. 8 is a graph showing the relationship between reflectivity as a function of incidence angle at 9.4 μm (CO₂ laser wavelength) on EAGLE XG® glass.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting. Additionally, any examples set forth in this specification are not limiting and merely set forth some of the many possible embodiments of the claimed invention.

Traditional laser-based, binder-less additive manufacturing methods of glass and glass ceramic articles have included glass-tubing, powder bed fusion, and blown-glass powder approaches. In particular, conventional glass-tubing processes involve using multiple laser beams to heat an external surface of the glass tubing from different directions. For example, the glass tubing is drawn in a vertical direction along a z-axis, and heated from approximately orthogonal directions along the x- and y-axis. The resulting melted glass may then be deposited or manipulated to form a glass article. To achieve uniformity of heat dispersion across the glass tubing external surface, at least three laser beams are required (e.g., by splitting one laser beam, using multiple lasers, or using multiple optical reflections). This configuration is often bulky, complex and introduces potential interference of the laser beam(s) with the as-made glass article.

The present application discloses methods of glass additive manufacturing using internal laser heating whereby laser light is coupled with glass tubing using a lens or optical fiber.

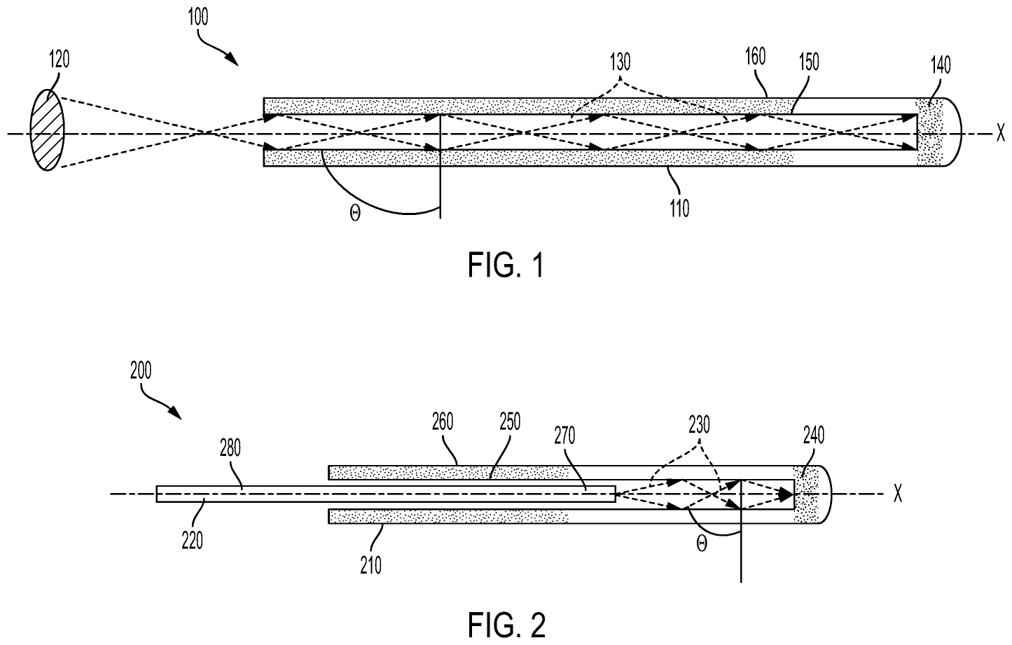

FIG. 1 illustrates an internal laser heating schematic according to some embodiments whereby light is coupled into a glass tube using a focusing lens. Configuration 100 includes a laser beam source (not shown) that is positioned along an x-axis (i.e., longitudinally) a predetermined distance away from a glass or glass ceramic tubular structure 110 and a focusing lens 120 placed in between the laser beam source and tubular structure 110. The tubular structure 110 has a partially closed end region 140, an interior surface 150, and exterior surface 160. A laser beam 130 is directed into and down the interior surface 150 of the glass or glass ceramic tubular structure 110 via focusing lens 120. In some implementations, the glass or glass ceramic tubular structure has an outer diameter having a length in a range of 500 μm to 10 mm and an inner diameter having a length in a range of 50 μm to 9 mm.

The laser beam source may comprise a gas laser such as CO₂ (wavelength, λ=9.4 μm to 10.6 μm); CO (λ=2.6 μm to 4 μm; 4.8 μm to 8.3 μm); mid-IR hybrid lasers (λ=1.64 μm to 5.2 μm); HeNe (λ=543.5 nm to 3.39 μm); N₂ (λ=244 nm to 528.7 nm); HF (λ=2.7 μm to 2.9 μm); deuterium fluoride (λ=3.8 μm); F₂ (λ=157 nm); noble gas compounds (ArF (λ=193 nm), KrCl (λ=222 nm), KrF (λ=248 nm), XeCl (λ=308 nm), and XeF (λ=351 nm)); Ar (λ=351 nm to 528.7 nm); metal-vapor (HeAg (λ=224 nm), NeCu (λ=248 nm), and HeCd (λ=325 nm)); or a combination thereof. In some embodiments, the laser beam has a wavelength in a range of 0.1 μm to 12 μm. In some embodiments, the laser beam has a wavelength in a range of 2μm to 12 μm.

The laser beam may have a linearly polarized (LP) mode comprising: LP₀₁, LP₀₂, LP₀₃, LP₀₄, LP₁₁, LP₁₂, LP₁₃, LP₂₁, LP₂₂, LP₂₃, LP₃₁, LP₃₂, LP₄₁, LP₄₂, LP₅₁, LP₅₂, LP₆₁, LP₇₁. In some embodiments, the laser beam has a linearly polarized LP mode comprising LP₀₁, LP₀₂, LP₀₃, LP₃₁ or LP₂₁. The laser beam may be operated with a power in a range of 100 mW to 1000 W. In some examples, the laser beam may be operated with a power in a range of 1 W to 500 W or in a range of 5 W to 100 W or in a range of 10 W to 50 W (e.g., 20 W).

As the laser beam 130 propagates down the interior surface 150 of the glass or glass ceramic tubular structure 110, a portion of the laser beam strikes the interior surface at an angle greater than a predetermined incidence angle θ. In some embodiments, the predetermined incidence angle is 75° or more. In some embodiments, the predetermined incidence angle is 80° or more. In some embodiments, the predetermined incidence angle is 85° or more. Because of this high incidence angle θ, light striking the interior surface of the glass or glass ceramic tubular structure is predominantly reflected and is capable of multiple surface reflections (prior to reaching the end region 140) without significantly dissipating energy.

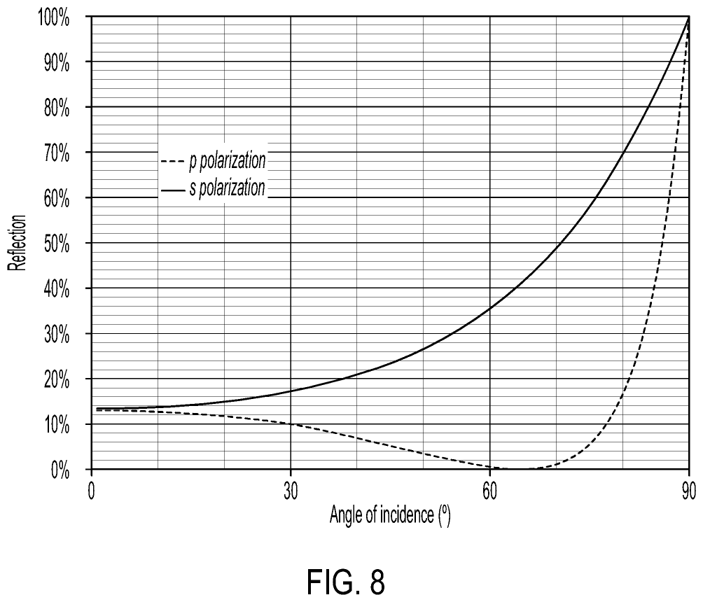

In one example, FIG. 8 shows the relationship between reflectivity of a CO₂ laser beam (λ=10.6 μm) on EAGLE XG® glass as a function of incidence angle. At higher incidence angles (e.g., at least 85°), most light is reflected (i.e., about 50% of p-polarized light and about 85% of s-polarized light). At normal incidence (i.e., incidence angle equals 0°), only about 14% of the laser light is reflected and greater than 80% of the light energy is absorbed by the glass.

The lens may be any suitable type (and be positioned at any appropriate location between the laser beam source and tubular structure) which allows focusing the laser beam in a manner where the predetermined incidence angle is at least 75° or at least 80° or at least 85°. For example, the lens may be at least one of biconvex, plano-convex, positive meniscus, negative meniscus, plano-concave, biconcave, or a combination thereof. In some implementations, the lens may have a numerical aperture in a range of 0.05 to 0.5.

Because of incidence angle θ0, the laser light is able to propagate down the glass or glass ceramic tubular structure 110 with minimal energy loss and strike end region 140 at near normal incidence, thereby resulting in absorption of energy and heating of end region 140 to a glass working range. The glass working range of end region 140 corresponds to a viscosity in a range of 4 to 7.6 Log₁₀ Poise. As used herein, “near normal” refers to an impingement angle of the laser light being 80°±10°. In some implementations, a portion of the laser light may also strike the end region at angles falling outside of near normal incidence. In other words, the laser beam 130 impinges on the closed end region 140 such that at least some of the laser beam is absorbed by the closed end region of the glass or glass ceramic tubular structure.

As a result of the energy absorption, the end region is heated to a temperature in a range of its glass working temperature, which is the range of temperatures that corresponds to the point where glass initially begins to soften (e.g., 7.6×10⁸ dPa·s, or the glass softening point) to the point where the glass is too soft to control (e.g., ˜10⁴ dPa·s). In some embodiments, the tubular structure and/or the end region may be a material comprising at least one of Corning PYREX®, Corning MACOR®, Corning LOTUS®, Corning GORILLA®, Corning EAGLE XG®, Corning FOTOFORM®, or Corning IRIS™ Glasses, for example as shown in U.S. Pat. Nos. 8,367,208, 8,598,055, 8,763,429, 8,796,165, and 9,517,967 and U.S. Patent Publication Nos. 2014/0106172 and 2015/0140299, all of which are herein incorporated by reference in their entireties. In some implementation, the glass or glass ceramic tubular structure and/or the end region has an absorbance of at least 0.05 at a wavelength of the laser beam.

Because of the penetration depth of the lasers used herein (CO₂, CO, etc.) to process glass is some hundreds of microns or less, interaction of the laser beam with the glasses disclosed above is confined within glass tubing, thereby eliminating potential safety hazards. Moreover, when the laser beam is aligned to the center of the end region, heating is conducted uniformly to achieve homogenous softening temperatures. As a result, due to surface tension, the melted end region collapses into a solid, molten glass that is used (i.e., consumed) in subsequent additive manufacturing process steps to make glass articles. For example, at least one of the glass or glass ceramic tubular structure or the end region is moved relative to each other such that at least a two-dimensional shape is formed from the glass or glass ceramic tubular structure. In some implementations, the at least two-dimensional shape is a three-dimensional shape. The three-dimensionally shaped articles can be produced on a support substrate or as unsupported, spatially independent structures.

In some examples, the laser beam source, glass or glass ceramic tubular structure and/or the end region is translated to enable continuous melting and processing. In some examples, the system may operate in a vacuum environment to facilitate melted end region collapse. In some examples, the tubular structure 110 may be rotated.

The additive manufacturing-formed glass article can be post-processed via most traditional methods used for glasses and glass ceramics and well known in the art, such as chemical tempering via ion exchange, chemical or physical etching, polishing, etc.

FIG. 2 illustrates an internal laser heating schematic according to some embodiments whereby light is coupled into a glass tube using optical fiber. Configuration 200 shows laser beam 230 propagating down a hollow-core guiding fiber 220 where it is eventually emitted by the fiber 220, and finally transmitted down an interior surface 250 of glass or glass ceramic tubular structure 210 at an angle equal to or greater than a predetermined incidence angle θ. In some examples, the guiding fiber 220 of configuration 200 is not hollow and the laser beam 230 is transmitted through the fiber via total internal reflection. In some examples, the fiber may have a cross-section profile in a shape of a circle or an oval. In some examples, the fiber has a radially symmetric index profile. The tubular structure 210 has a partially closed end region 240, an interior surface 250, and exterior surface 260. Similar to configuration 100 above, laser beam 230 impinges end region 240 to heat it to at least its softening point. Configuration 200 hereby incorporates the pertinent elements of configuration 100 described above such as laser beam and/or source characteristics, incidence angle θ mechanics, materials, and heating dynamics of the end region, for example.

In some embodiments, the coupling of the laser light to the glass tube is accomplished by providing a laser inside the glass or glass ceramic tubular structure 210 via a glass or polymer fiber 220 (having a distal end 270 and a proximal end 280). For example, in some embodiments, fiber 220 may be a material comprising at least one of silica, fluoride-based glasses (e.g., fluorozirconate, fluoroaluminate, etc.), phosphate-based glasses (e.g., metaphosphates of various metals), chalcogenide glasses (e.g., comprising at least one chalcogens (sulfur, selenium and tellurium, but excluding oxygen)), crystalline materials (e.g., sapphire, FIR-transmitting polycrystalline AgClₓBr_{y}), PMMA (acrylic), fluorinated polymers, amorphous fluoropolymer (e.g., poly(perfluoro-butenylvinyl ether)), or a combination thereof. In some examples, either the distal end or the proximal end (e.g., at the tip) may comprise a focusing lens.

The distance between the distal end 270 and the end region 240 may be varied accordingly depending on the laser light source characteristics, fiber material used, end region material, and desired properties of the resultant molten glass for forming glass articles. The distance between the distal end and the end region may be varied in a range of 1 mm to 1000 mm. In some examples, the distance between the distal end and the end region may be in a range of 25 mm to 750 mm or in a range of 50 mm to 500 mm, or in a range of 75 mm to 250 mm (e.g., 100 mm).

As the laser light beam 230 exits the optical fiber 220, the beam 230 reflects off the interior surface 250 of the glass or glass ceramic tubular structure 210 several times before reaching the sealed end region 240. Similar to configuration 100, the walls of the glass or glass ceramic tubular structure 210 may experience minimal heating due to energy absorption from the multiple impingements of the beam 230 with the interior surface 250. Energy absorbed by the glass or glass ceramic tubular structure 210 through interior surface 250 initiates preheating of the end region 240, thereby reducing thermal shock. Though a portion of the laser beam's energy is absorbed through the sidewalls, most of it reaches the sealed end region at near normal incidence and is predominantly absorbed, with a small fraction being reflected. The laser characteristics (i.e., power, distance from end region, etc.) are determined so as to achieve end region melting. Thus, the end region may be gradually melted by a combination of laser heating and thermal conduction.

In some examples, a CO₂ laser beam is coupled into a soda lime glass tubular structure using a hollow core CO₂ laser fiber. Due to preferential heating, the end region melts and the melted glass is used in an additive manufacturing process to form a glass article as the tubular structure and end region are moved away from the distal end of the CO₂ laser fiber. In some examples, the glass article may be formed by moving away the distal end of the fiber containing the laser beam source by pulling from the proximal end. In some examples, the glass article may be formed by movement of both the tubular structure and end region and the distal end of the fiber. The relative speed of movement of the tubular structure/end region or the distal end of the fiber may be in a range of 1 mm/s to 100 mm/s. In some examples, the relative speed of movement of the tubular structure/end region or the distal end of the fiber may be in a range of 5 mm/s to 50 mm/s (e.g., 10 mm/s) to form a Y-shaped glass article.

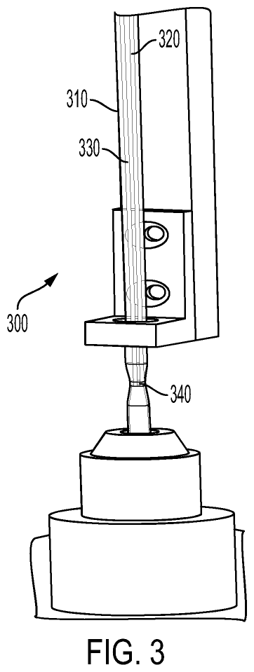

FIG. 3 illustrates an experimental scheme 300 of an internal laser heating schematic utilizing optical fiber (for example, as in configuration 200) whereby a laser beam 330 propagates down a guiding fiber 320 where it is eventually emitted by the fiber 320, and finally transmitted down an interior surface of glass or glass ceramic tubular structure 310 toward a target end region 340 of the glass or glass ceramic tubular structure. While FIG. 3 is depicted in a vertical orientation, similar schemes may be configured in any arrangements without taking away from the scope and spirit of the disclosure (e.g., horizontal, rotated 180°, etc.).

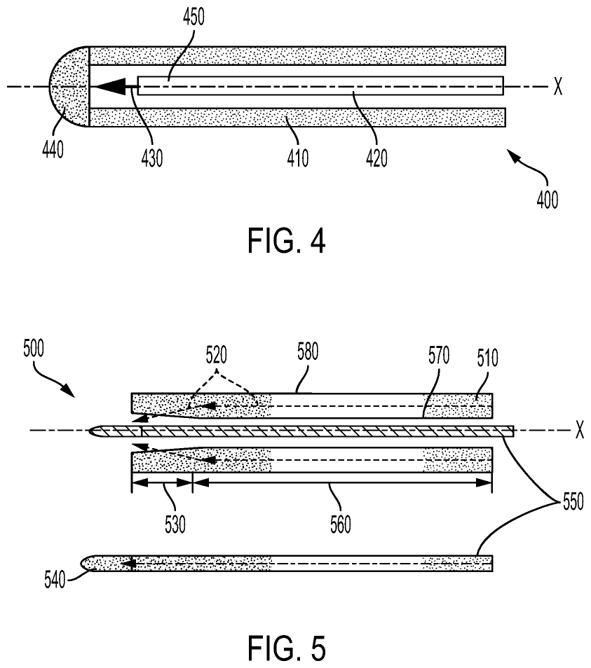

FIG. 4 illustrates an internal laser heating schematic according to some embodiments whereby light is coupled into a glass tube using optical fiber. Configuration 400 shows laser beam 430 propagating down a guiding fiber 420 where it is eventually emitted by the fiber 420, and finally transmitted down an interior of glass or glass ceramic tubular structure 410 toward an end region 440 of the glass or glass ceramic tubular structure. Similar to configurations 100 and 200 above, laser beam 430 impinges end region 440 to heat it to at least its softening point.

In the configuration of FIG. 4, the distance between the distal end 450 and the end region 440 may be varied in a range where interactions between the laser beam and glass or glass ceramic tubular structure are inconsequential. In other words, there is a minimal amount of energy absorbed by the glass or glass ceramic tubular structure such that there is no preheating of the end region 440. Thus, almost all of the laser beam's energy reaches the sealed end region at near normal incidence and is predominantly absorbed, with a small fraction being reflected. The laser characteristics (i.e., power, distance from end region, etc.) are determined so as to achieve end region melting. Thus, the end region may be gradually melted by laser heating. In some examples, the distance between the distal end and the end region may be in a range of 1 mm to 100 mm. In some examples, the distal end may comprise a focusing lens (e.g., at the tip).

Configuration 400 hereby incorporates the pertinent elements of configuration 200 described above such as fiber materials and characteristics and movement speeds, for example.

FIG. 5 illustrates an internal laser heating schematic according to some embodiments whereby light is transmitted by optical fiber. Configuration 500 shows laser beam 520 propagating through a solid-core guiding fiber 510 (i.e., a glass or glass ceramic tubular structure) by total internal reflection where it is eventually emitted through a focusing region 530 of the guiding fiber 510 to heat an end region 540 of a glass or glass ceramic cylindrical structure 550. As laser beam 520 traverses tubular structure 510 via total internal reflection, the walls of the tubular structure 510 may experience minimal heating due to energy absorption from the multiple impingements of the beam. In some examples, the guiding fiber may be a hollow tube having an interior surface, a continuously solid tube or a combination thereof.

The glass or glass ceramic cylindrical structure 550 has an exterior surface, an exterior diameter, and at least a partially closed end region 540. The cylindrical structure may be a hollow tube having an interior surface, a continuously solid tube or a combination thereof. In some examples, the exterior diameter of the glass or glass ceramic cylindrical structure is in a range of 1 mm to 20 mm. In some examples, the exterior diameter of the glass or glass ceramic cylindrical structure may be in a range of 2 mm to 7 mm.

The tubular structure 510 has an interior surface 570, an exterior surface 580, an interior diameter, an exterior diameter, and a focusing region 530. The tubular structure 510 may have an approximately uniform thickness longitudinally along the x-axis until the focusing region 530 is reached. At this juncture, the portion of the interior surface 570 defining the focusing region 530 tapers (or, for example, curves) such that the interior diameter increases and approaches the exterior diameter. As the laser beam 520 propagates through the uniform thickness portion 560 of tubular structure 510 by total internal reflection, the beam oscillates between striking the boundary defined by the exterior surface 580 and the boundary defined by the interior surface 570. The beam remains confined within tubular structure 510 because the angle at which it strikes (i.e., incidence angle) either the interior surface 570 or the exterior surface 580 is larger than a critical angle with respect to the normal to the surface. If the refractive index is lower outside of the tubular structure, and the incidence angle is greater than the critical angle, the laser beam cannot pass through the boundary defined by the exterior surface 580 and the boundary defined by the interior surface 570, and is thus completely reflected. The critical angle is the incidence angle above which total internal reflectance occurs.

Based on a desired focus point (i.e., area where the cylindrical structure 550 is positioned inside the tubular structure 510 such that the end region 540 of the cylindrical structure experiences the laser heating process), the angle and length of the tapered portion of the interior surface 570 in focusing region 530 is predetermined. The tapered portion changes the incidence angle of the impinging beam (based on the angle and length of the tapered interior surface 570) such that it becomes smaller than the critical angle with respect to the normal to the surface, thereby allowing the laser beam to exit the tubular structure 510 and toward the end region 540 of the cylindrical structure 550 which is heated to at least its softening point.

In some examples, the exterior diameter of the glass or glass ceramic tubular structure may be in a range of 500 μm to 10 mm while the interior diameter of the glass or glass ceramic tubular structure is in a range of 50 μm to 9 mm. In other examples, the exterior diameter of the glass or glass ceramic tubular structure is in a range of 2 mm to 7 mm while the interior diameter of the glass or glass ceramic tubular structure is in a range of from at least a wavelength of the laser beam to 6.95 mm. In some examples, the interior diameter of the tubular structure is greater than the exterior diameter of the cylindrical structure.

The end region 540 melts and the melted glass is used in subsequent additive manufacturing processes to form a glass article. At least one of the tubular structure 510 or the end region is moved relative to each other such that at least a two-dimensional shape is formed from the glass or glass ceramic cylindrical structure.

Configuration 500 hereby incorporates the pertinent elements of configurations 100, 200, and 400 described above such as laser beam and/or source characteristics, materials, and heating dynamics of the end region, fiber materials and characteristics and movement speeds, for example.

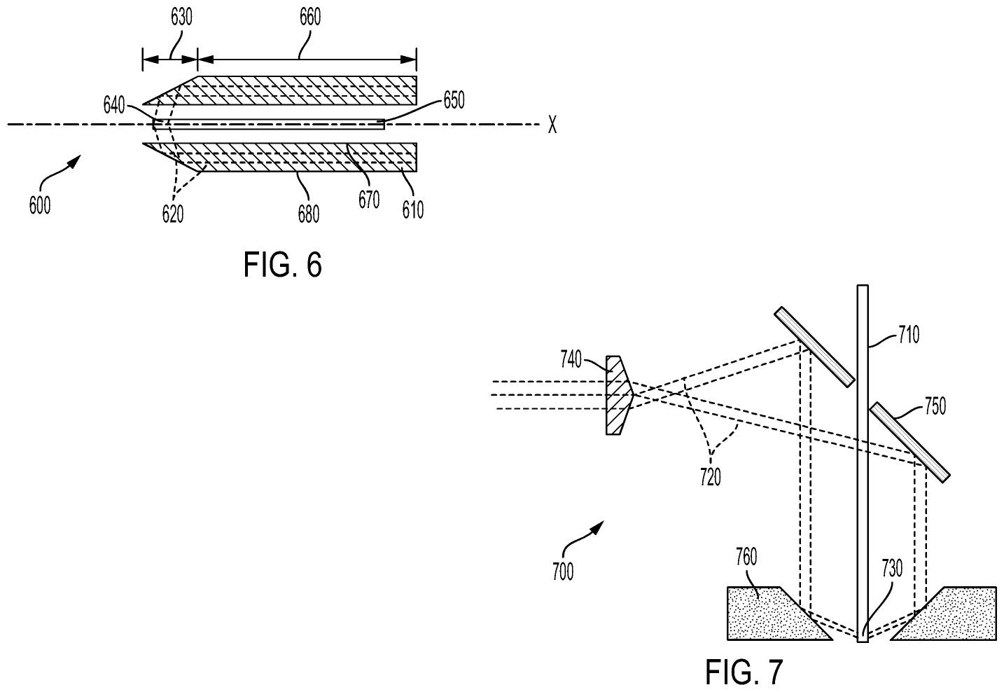

FIG. 6 illustrates an internal laser heating schematic according to some embodiments whereby light is transmitted by optical fiber. Configuration 600 shows laser beam 620 propagating through a solid-core guiding fiber 610 (i.e., a glass or glass ceramic tubular structure) by total internal reflection where it is eventually emitted through a focusing region 630 of the guiding fiber 610 to heat an end region 640 of a glass or glass ceramic cylindrical structure 650. As laser beam 620 traverses tubular structure 610 via total internal reflection, the walls of the tubular structure 610 may experience minimal heating due to energy absorption from the multiple impingements of the beam. In some examples, the guiding fiber may be a hollow tube having an interior surface, a continuously solid tube or a combination thereof.

The glass or glass ceramic cylindrical structure 650 has an exterior surface, an exterior diameter, and at least a partially closed end region 640. The cylindrical structure may be a hollow tube having an interior surface, a continuously solid tube or a combination thereof. In some examples, the exterior diameter of the glass or glass ceramic cylindrical structure is in a range of 1 mm to 20 mm. In some examples, the exterior diameter of the glass or glass ceramic cylindrical structure may be in a range of 2 mm to 7 mm.

The tubular structure 610 has an interior surface 670, an exterior surface 680, an interior diameter, an exterior diameter, and a focusing region 630. The tubular structure 610 may have an approximately uniform thickness portion 660 longitudinally along the x-axis until the focusing region 630 is reached. At this juncture, the portion of the exterior surface 680 defining the focusing region 630 tapers (or, for example, curves) as it approaches the interior surface 670 such that the exterior diameter decreases and approaches the interior diameter.

Similar to configuration 500, laser beam 620 propagates through the uniform thickness portion 660 of tubular structure 610, the beam oscillates between striking the boundary defined by the exterior surface 680 and the boundary defined by the interior surface 670. The beam remains confined within tubular structure 610 because the incidence angle at either the interior surface 670 or the exterior surface 680 is larger than a critical angle with respect to the normal to the surface. Based on a desired focus point, the angle and length of the tapered portion of the exterior surface 680 in focusing region 630 is predetermined. The tapered portion changes the incidence angle of the impinging beam such that it becomes smaller than the critical angle with respect to the normal to the surface, thereby allowing the laser beam to exit the tubular structure 610 and toward the end region 640 of the cylindrical structure 650 which is heated to at least its softening point. In other words, focusing region 630 may be machined to an acute angle to function as a reflector. Laser beam 620 is reflected toward the end region 640 through either total internal reflection or reflection coatings.

The end region 640 melts and the melted glass is used in subsequent additive manufacturing processes to form a glass article. At least one of the tubular structure 610 or the end region is moved relative to each other such that at least a two-dimensional shape is formed from the glass or glass ceramic cylindrical structure.

Configuration 600 hereby incorporates the pertinent elements of configurations 100, 200, 400, and 500 described above such as laser beam and/or source characteristics, materials, and heating dynamics of the end region, fiber materials, size configurations of the cylindrical and/or tubular structure, and characteristics and movement speeds, for example.

FIG. 7 illustrates configuration 700 for heating an end region 730 of a glass or glass ceramic cylindrical structure 710 with laser beam 720, the configuration having a combination of axicon lens 740, parabolic mirror 750 and conical reflector 760. The axicon lens 740 transforms a round laser beam into a diverging ring-shaped beam as it strikes the parabolic mirror 750. The diverging ring-shaped beam may be transformed into a constant diameter ring-shaped beam by parabolic mirror 750. In some examples, the parabolic mirror 750 may be configured to include a hole in a predetermined location to allow insertion of the glass or glass ceramic cylindrical structure 710 whereby the end region 730 becomes a focal point of the laser beam 720 after reflection off the conical reflector 760 to achieve uniform heating of cylindrical structure 710.

Alternatively, conical reflector 760 may be substituted or used conjointly with a cylindrical concentrator optics (not shown) comprising IR-transmitting materials (e.g., Ge, ZnSe, etc.). All IR-transmitting materials have high refractive index at CO₂ laser wavelength. Critical angles of incidence for Ge and ZnSe using a 10.6 μm wavelength CO₂ laser is 14.5° and 24.6°. At incident angles greater than the critical angles, the laser beam is totally internal reflected. Anti-reflective coatings may be applied on entrance and exit surfaces to increase transmission of the laser beam.

The end region 730 melts and the melted glass is used in subsequent additive manufacturing processes to form a glass article. The end region 730 may be moved relative to the combination of axicon lens 740, parabolic mirror 750, conical reflector 760 and/or cylindrical concentrator optics such that at least a two-dimensional shape is formed from the glass or glass ceramic cylindrical structure.

Configuration 700 hereby incorporates the pertinent elements of configurations 100, 200, and 400-600 described above such as laser beam and/or source characteristics, materials, and heating dynamics of the end region, fiber materials, size configurations of the cylindrical and/or tubular structure, lens characteristics, and characteristics and movement speeds, for example.

Thus, as provided herein, the present application discloses methods of glass additive manufacturing using internal laser heating that can provide cost savings and/or improved timelines compared with other machining methods, and allow for high resolution, three-dimensional, laser-processed glass or glass ceramic articles having unique properties not attainable with traditional AM processes. For example, while processed similar to polymer systems, the three-dimensional AM-printed articles have properties much different from conventional resin or polymer resin systems, such as high strengths and hardnesses. Moreover, the present disclosure simplifies additive manufacturing glass printing processes; provides uniform heating of glass; eliminates interference of laser beam delivery and fiber feed processes, and scattered light, and unwanted laser heating; enables simultaneous heating of multiple glass fibers; and enables glass additive manufacturing using multiple tubings with different compositions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A method for forming a structure comprising:
providing a glass or glass ceramic tubular structure having an interior and exterior surface and at least a partially closed end region;
heating the glass or glass ceramic tubular structure to at least its softening point by:
(i) providing a laser beam;
(ii) directing the laser beam down the interior surface of the glass or glass ceramic tubular structure;
(iii) wherein at least some of the laser beam is directed at an angle greater than a predetermined incidence angle; and
(iv) the laser beam impinges on the closed end region such that at least some of the laser beam is absorbed by the closed end region of the glass or glass ceramic tubular structure; and
moving at least one of: the glass or glass ceramic tubular structure or the end region relative to each other such that at least a two-dimensional shape is formed from the glass or glass ceramic tubular structure.

2. The method of claim 1, wherein the step of providing the laser beam comprises directing the laser beam into the glass or glass ceramic tubular structure via an optical lens.

3. The method of claim 1, wherein the step of providing the laser beam comprises positioning the laser inside the glass or glass ceramic tubular structure via a glass or polymer fiber.

4. The method of claim 3, wherein the glass or polymer fiber is hollow and has an interior surface, wherein the beam is transmitted through the glass or polymer fiber via reflection off the interior surface at an angle greater than the predetermined incidence angle.

5. The method of claim 3, wherein the glass or polymer fiber is not hollow and the beam is transmitted through the glass or polymer fiber via total internal reflection.

6. The method of claim 3, wherein the glass or polymer fiber has a radially symmetric index profile.

7. The method of claim 1, where the predetermined incidence angle is 85° or more.

8. The method of claim 1, wherein the laser beam has a wavelength in a range of 2 μm to 12 μm.

9. The method of claim 1, wherein the laser beam has a linearly polarized LP mode comprising LP₀₁, LP₀₂, LP₀₃, LP₃₁ or LP₂₁.

10. The method of claim 1, wherein the glass or glass ceramic tubular structure has an absorbance of at least 0.05 at a wavelength of the laser beam.

11. The method of claim 1, wherein the glass or glass ceramic tubular structure has an outer diameter and an inner diameter, the outer diameter being from 500 μm to 10 mm and the inner diameter being from 50 μm to 9 mm.

12. The method of claim 1, wherein the at least two-dimensional shape is a three-dimensional shape.

13. A method of forming an article comprising:
providing a glass or glass ceramic cylindrical structure having an exterior surface, an exterior diameter, and an end region;
providing a glass or glass ceramic tubular structure having an interior surface, an exterior surface, an interior diameter, an exterior diameter, and a focusing region, wherein the interior diameter of the glass or glass ceramic tubular structure is greater than the exterior diameter of the glass or glass ceramic cylindrical structure;
positioning the glass or glass ceramic cylindrical structure inside the glass or glass ceramic tubular structure such that the end region of cylindrical structure is positioned in the focusing region of the tubular structure;
heating the glass or glass ceramic cylindrical structure to at least its softening point by:
(i) providing a laser beam;
(ii) directing the laser beam through the glass or glass ceramic tubular structure via total internal reflection;
(iii) wherein at least some of the laser beam exits the focusing region; and
(iv) the laser beam impinges on the end region such that at least some of the laser beam is absorbed by the end region; and
moving at least one of the glass or glass ceramic tubular structure or the end region relative to each other such that at least a two-dimensional shape is formed from the glass or glass ceramic cylindrical structure.

14. The method of claim 13, wherein the glass or glass ceramic cylindrical structure comprises a hollow tube having an interior surface and wherein the end region is at least partially closed.

15. (canceled)

16. The method of claim 13, wherein the step of providing the laser beam comprises positioning the laser inside the glass or glass ceramic tubular structure via a glass or polymer fiber.

17. (canceled)

18. (canceled)

19. The method of claim 13, wherein the glass or glass ceramic cylindrical structure has an absorbance of at least 0.05 at a wavelength of the laser beam.

20. The method of claim 13, wherein the exterior diameter of the glass or glass ceramic tubular structure is in a range of 500 μm to 10 mm and the interior diameter of the glass or glass ceramic tubular structure is in a range of 50 μm to 9 mm; and the exterior diameter of the glass or glass ceramic cylindrical structure is in a range of 1 mm to 20 mm.

21. (canceled)

22. The method of claim 13, wherein the at least two-dimensional shape is three-dimensional shape.

23. The method of claim 13, further comprising: tapering a portion of the interior surface of the glass or glass ceramic tubular structure such that the interior diameter of the glass or glass ceramic tubular structure increases to approach the exterior diameter of the glass or glass ceramic tubular structure.

24. The method of claim 13, further comprising: tapering a portion of the exterior surface of the glass or glass ceramic tubular structure such that the exterior diameter of the glass or glass ceramic tubular structure decreases to approach the interior diameter of the glass or glass ceramic tubular structure.

25-28. (canceled)
